(19) United States
(12) Patent Application Publication
(10) Pub. No.: US 2022/0071229 A1
(43) Pub. Date: Mar. 10, 2022

(54) CHOCOLATE-LIKE PRODUCT AND METHOD FOR PREPARING THE SAME

(71) Applicant: Wei KU, Taipei (TW)

(72) Inventor: Wei KU, Taipei (TW)

(21) Appl. No.: 17/468,043

(22) Filed: Sep. 7, 2021

(30) Foreign Application Priority Data
Sep. 9, 2020 (TW) 109130901

(51) Int. Cl. A23G 1/48; A23G 1/36; A23G 1/40; A23G 1/00

(52) U.S. Cl. CPC A23G 1/48; A23G 1/36; A23V 2002/00; A23G 1/005; A23G 1/40

(57) ABSTRACT

The present invention provides a chocolate-like product and a method for preparing the same. The chocolate-like product has a unique flavor and includes a cocoa butter; a sweetener; an ingredient made from fruit-fermented wine lees; and an ingredient made from soybeans.

### BACKGROUND OF THE INVENTION

### Field of the Invention

The present invention relates to a chocolate-like product and, in particular, to a chocolate-like product that can be used as a dessert and contains an ingredient made from fruit-fermented wine lees.

### Description of the Prior Art

Chocolate is a popular dessert for consumers because of its unique flavor and taste. In order to strengthen food safety and hygiene management, Taiwan began to implement the “Regulations Governing the Product Name and Labeling of Chocolate” on Jan. 1, 2017 to regulate the product name of chocolate for protecting the knowing rights and interests of consumers, which shows how much chocolate is loved by consumers.

According to the “Regulations Governing the Product Name and Labeling of Chocolate”, chocolate can be divided into solid dark chocolate without filling, milk chocolate and white chocolate. The definition of white chocolate is that it should use cocoa butter and milk powder as raw materials, and its cocoa butter content is at least 20%, and the milk solids is at least 14%. Since dairy products and animal products are considered to be one of the driving forces of global warming, white chocolate containing animal milk powder is inconsistent with the current trend of “vegetable” diets.

The raw materials for making chocolate cannot contain moisture, so currently there is no chocolate-like product with wine taste in totally solid form. Chocolate products with wine taste are all solid chocolates filled with wine to make them have wine taste. However, once the outer layer of chocolate melts or breaks, the liquid filling is easy to flow out, resulting in problems of storage and carrying difficulty.

### SUMMARY OF THE INVENTION

In view of the above technical problems, an object of the present invention is to provide a novel chocolate-like product with a unique flavor.

Another object of the present invention is to provide a novel chocolate-like product that can use only a small amount of animal milk powder or even no animal milk powder at all.

A further object of the present invention is to provide a novel chocolate-like product with a wine taste without filling.

In order to achieve the above objects, the present invention provides a chocolate-like product, which comprises: a cocoa butter; a sweetener; an ingredient made from fruit-fermented wine lees; and an ingredient made from soybeans.

Preferably, the sweetener is sugar, vanilla or a combination thereof.

Preferably, the fruit-fermented wine lees are obtained by brewing wine.

Preferably, the ingredient made from the fruit-fermented wine lees is powdery fruit-fermented wine lees.

Preferably, a content of the cocoa butter is 30-50 wt %, a content of the sweetener is 20-40 wt %, and a content of the ingredient made from the fruit-fermented wine lees is 10-30 wt %.

Preferably, the ingredient made from soybeans is soybean powder.

Preferably, a content of the cocoa butter is 30-50 wt %, a content of the sweetener is 20-40 wt %, a content of the ingredient made from the fruit-fermented wine lees is 10-30 wt %, and a content of the ingredient made from soybeans is 2.5-20 wt %.

Preferably, the chocolate-like product is a dessert.

The present invention further provides a method for preparing a chocolate-like product, which comprises the following steps: (a) providing a mixture comprising a cocoa butter, a sweetener, fruit-fermented wine lees, and soybeans; (b) grinding the mixture; and (c) tempering the ground mixture.

Preferably, the step (a) comprises the following steps: grinding the fruit-fermented wine lees into powder, which is then mixed with the cocoa butter, the sweetener and the soybeans in powder form to obtain the mixture.

Preferably, the tempering comprises the following steps: heating the ground mixture to about 42° C. to obtain a heated mixture; cooling the heated mixture to about 25° C. to obtain a cooled mixture; and heating the cooled mixture to about 30° C.

Preferably, the method further includes a shaping step after the step (c). More preferably, the method further includes a packaging step after the shaping step.

Preferably, a content of the cocoa butter is 30-50 wt %, a content of the sweetener is 20-40 wt %, a content of the fruit-fermented wine lees is 10-30 wt %, and a content of the soybeans is 2.5-20 wt %.

The present invention introduces the ingredient made from the fruit-fermented wine lees into the chocolate-like product such that the chocolate-like product of the present invention has a flavor different from that of the traditional chocolate-like products. Besides, because the chocolate-like product of the present invention contains the ingredient made from the fruit-fermented wine lees, it can achieve the purpose of having a wine taste without containing the filling, thereby solving the long-standing technical problem that the chocolate-like product in solid form must contain the filling to own the wine taste.

### DETAILED DESCRIPTION OF THE EMBODIMENTS

The term “chocolate-like product” as used in the present invention refers to a product using cocoa products as raw materials. The composition of the chocolate-like product may or may not met the requirements of Taiwan's “Regulations Governing the Product Name and Labeling of Chocolate” for dark chocolate, milk chocolate and white chocolate products.

The term “fruit-fermented wine lees” as used in the present invention refers to the residue of fermented products produced from brewing fruit wine.

The chocolate-like product provided by the present invention includes: a cocoa butter; a sweetener; an ingredient made from fruit-fermented wine lees; and an ingredient made from soybeans. The content of the cocoa butter is preferably 30-50 wt %, such as 35-45 wt %, 35-43 wt %, or 37-47 wt %.

In order to make the chocolate-like product have a better flavor, the content of the sweetener is preferably 20-40 wt %, such as 25-40 wt %, 25-35 wt %, 22-30 wt %, 23-30 wt %, 20-28 wt %, or 22-27 wt %. The type of the sweetener is not particularly limited, as long as the sweetener has the function of imparting sweetness. The sweetener can be sugar (such as crystal sugar), vanilla or a combination thereof, but is not limited thereto.

In order to make the chocolate-like product of the present invention have a flavor different from that of traditional chocolate-like products, the chocolate-like product of the present invention includes an ingredient made from soybeans. In order to make the product have a better flavor, the content of the ingredients made from soybeans can be 2.5-20 wt %, such as 5-20 wt %, 10-20 wt %, 12-20 wt %, 5-18 wt %, 10-18 wt %, or 13-17 wt %. The ingredient made from soybeans is preferably soybean powder. In a preferred embodiment, the ingredient made from soybeans is prepared by heat treatment and then grinding of soybeans.

In addition, in order to comply with the current trend of “vegetable” diet, the present invention can partially or completely replace the animal milk powder in white chocolate with the ingredient made from soybeans, thereby reducing the use of the animal milk powder or even using no animal milk powder at all. In other words, in a preferred embodiment, the chocolate-like product does not contain any animal milk powder. The ingredient made from soybeans can be used as a source of natural lecithin, which can even make the chocolate-like product of the present invention achieve the purpose of using no soy/sunflower seed lecithin. Therefore, the chocolate-like product of the present invention preferably does not contain any soy lecithin, sunflower seed lecithin or a combination thereof.

Preferably, the chocolate-like product of the present invention does not contain any vanilla, spices, soy lecithin, sunflower seed lecithin or a combination thereof.

The present invention can make the chocolate-like product has a wine taste by using the ingredient made from the fruit-fermented wine lees. The fruit-fermented wine lees may be the fermented pulp, fermented peel, fermented seeds, brewing yeast or a combination thereof (such as of three or four among the forgoing). The fruit-fermented wine lees can be obtained by brewing wine (such as white wine or red wine). In order to make the chocolate-like product has a better flavor, the content of the ingredient made from the fruit-fermented wine lees is preferably 10-30 wt %, such as 13-30 wt %, 15-30 wt %, 10-27 wt % or 12-27 wt %. The ingredient made from the fruit-fermented wine lees may be powdery fruit-fermented wine lees. It can be seen from the above that the chocolate-like product of the present invention can be in the solid form without the filling.

The present invention also provides a method for preparing a chocolate-like product, which includes the following steps: (a) providing a mixture comprising a cocoa butter, a sweetener, fruit-fermented wine lees, and soybeans; (b) grinding the mixture; and (c) tempering the ground mixture. The step (a) can be carried out by the following steps: grinding the fruit-fermented wine lees into powder, which is then mixed with the cocoa butter and the sweetener to obtain the mixture. The method may further include a step of conching the ground mixture after the step (b) and before the step (c). In a preferred embodiment, the total time for the grinding step and the conching step is 24 to 72 hours.

In a preferred embodiment, the content of the cocoa butter is 30-50 wt %, the content of the sweetener is 20-40 wt %, and the content of the fruit-fermented wine lees is 10-30 wt %.

In a preferred embodiment, the step (a) can be carried out by the following steps: grinding the fruit-fermented wine lees to form powder, and then mixing with the cocoa butter, the sweetener and the soybean powder to obtain the mixture. In a preferred embodiment, the content of the cocoa butter is 30-50 wt %, the content of the sweetener is 20-40 wt %, the content of the fruit-fermented wine lees is 10-30 wt %, and the content of the soybean is 2.5-20 wt %.

The tempering may comprise the following steps: heating the ground mixture to about 42° C. to obtain a heated mixture; cooling the heated mixture to about 25° C. to obtain a cooled mixture; and heating the cooled mixture to about 30° C. The tempering treatment can properly crystallize the cocoa butter and improve the gloss of the chocolate-like product.

The method may further include a shaping step after the step (c). In a preferred embodiment, the method further includes a packaging step after the shaping step.

The present invention will be further illustrated by the following embodiments. However, these embodiments are not intended to limit the scope of the present invention. All the changes and modifications made by people having ordinary skill in the art without departing from the spirit of the present invention fall within the scope of the present invention.

### Example 1

The materials includes: (1) cocoa butter; (2) crystal sugar; (3) fruit-fermented wine lees obtained by brewing black queen grape wine; and (4) soybean powder obtained by steaming and grinding soybeans.

200 grams of dried (e.g., vacuum freeze-drying) and powdered fruit-fermented wine lees were mixed with 450 grams of cocoa butter, 300 grams of crystal sugar and 50 grams of soybean powder to obtain a mixture. The mixture was milled for 48 hours, and then the tempering treatment was performed by the following process: the milled mixture was first heated to 42° C., then slowly cooled to 25° C., and then slowly heated to 30° C. to obtain a crude product. The crude product was further shaped in a mold and then packaged to obtain the final product of the chocolate-like product of the present invention. In this embodiment, the chocolate-like product did not contain milk powder (such as animal milk powder), and its composition was 45 wt % cocoa butter; 30 wt % sweetener (crystal sugar); 20 wt % fruit-fermented wine lees; and 5 wt % soybean powder.

### Example 2

Another chocolate-like product was prepared according to the same method as Example 1, except that the weight of the dried and powdered wine lees was changed to 220 grams, the weight of cocoa butter was changed to 400 grams, the weight of crystal sugar was changed to 350 grams, and the weight of soybean powder was changed to 30 grams. In this embodiment, the chocolate-like product did not contain milk powder (such as animal milk powder), and its composition was 40 wt % cocoa butter; 35 wt % sweetener (crystal sugar); 22 wt % fruit-fermented wine lees; and 3 wt % soybean powder.

The above are only preferred embodiments of the present invention, and should not be used to limit the implementation scope of the present invention, which means all the simple and equivalent changes and modifications based on the claims and description of the invention should still fall within the scope of the present invention.

What is claimed is:

1. A chocolate-like product, comprising:
a cocoa butter;
a sweetener;
an ingredient made from fruit-fermented wine lees; and
an ingredient made from soybeans.

2. The chocolate-like product of claim 1, wherein the sweetener is sugar, vanilla or a combination thereof.

3. The chocolate-like product of claim 1, wherein the fruit-fermented wine lees is obtained by brewing wine.

4. The chocolate-like product of claim 1, wherein the ingredient made from the fruit-fermented wine lees is powdery fruit-fermented wine lees.

5. The chocolate-like product of claim 1, wherein a content of the cocoa butter is 30-50 wt %, a content of the sweetener is 20-40 wt %, and a content of the ingredient made from the fruit-fermented wine lees is 10-30 wt %.

6. A chocolate-like product of claim 1, wherein the ingredient made from soybeans is soybean powder.

7. The chocolate-like product of claim 1, wherein a content of the cocoa butter is 30-50 wt %, a content of the sweetener is 20-40 wt %, a content of the ingredient made from the fruit-fermented wine lees is 10-30 wt %, and a content of the ingredient made from soybeans is 2.5-20 wt %.

8. The chocolate-like product of claim 1, which is a dessert.

9. A method for preparing a chocolate-like product, comprising the following steps:
(a) providing a mixture comprising a cocoa butter, a sweetener, fruit-fermented wine lees, and soybeans;
(b) grinding the mixture; and
(c) tempering the ground mixture.

10. The method of claim 9, wherein the step (a) comprises the following steps: grinding the fruit-fermented wine lees into powder, which is then mixed with the cocoa butter, the sweetener and the soybeans in powder form to obtain the mixture.

11. The method of claim 9, wherein the tempering comprises the following steps:
heating the ground mixture to about 42° C. to obtain a heated mixture;
cooling the heated mixture to about 25° C. to obtain a cooled mixture; and
heating the cooled mixture to about 30° C.

12. The method of claim 9, further comprising a shaping step after the step (c).

13. The method of claim 12, further comprising a packaging step after the shaping step.

14. The method of claim 9, wherein a content of the cocoa butter is 30-50 wt %, a content of the sweetener is 20-40 wt %, a content of the fruit-fermented wine lees is 10-30 wt %, and a content of the soybeans is 2.5-20 wt %.
